(19) United States
(12) Patent Application Publication
(10) Pub. No.: US 2026/0066302 A1
(43) Pub. Date: Mar. 5, 2026

(54) CATHODE FOR SECONDARY BATTERY AND LITHIUM SECONDARY BATTERY INCLUDING THE SAME

(71) Applicant: SK ON CO., LTD., Seoul (KR)

(72) Inventors: Jae Ram KIM, Daejeon (KR); Ji Hee BAE, Daejeon (KR); Yeon Hwa SONG, Daejeon (KR); Jeong Seok YEON, Daejeon (KR)

(21) Appl. No.: 19/287,822

(22) Filed: Aug. 1, 2025

(30) Foreign Application Priority Data
Aug. 28, 2024 (KR) 10-2024-0115976

(51) Int. Cl. H01M 4/62; H01M 4/131; H01M 4/58; H01M 10/052

(52) U.S. Cl. CPC H01M 4/623; H01M 4/131; H01M 4/5825; H01M 10/052

(57) ABSTRACT

A cathode for a secondary battery according to embodiments of the present disclosure includes a cathode current collector and a cathode active material layer, and the cathode active material layer includes a cathode active material and a binder. The cathode active material includes first particles including lithium iron phosphate. The binder includes a first fluorine-based polymer and a second fluorine-based polymer having a hydrophilic functional group bound to the first fluorine-based polymer.

### CROSS-REFERENCE TO RELATED APPLICATIONS

This patent application claims the benefit of priority under 35 U.S.C. § 119(a) to Korean Patent Applications No. 10-2024-0115976, filed on Aug. 28, 2024, the entire disclosure of which is incorporated herein by reference.

### BACKGROUND

### 1. Field of the Invention

The present disclosure relates to a cathode for a secondary battery and a lithium secondary battery including the same.

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, battery packs including the secondary battery have also been developed and applied to eco-friendly automobiles such as a hybrid vehicle, etc. as their power sources.

Examples of the secondary batteries may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

The lithium secondary battery may include, for example, an electrode assembly including a cathode, an anode and a separation membrane interposed between the cathode and the anode, and an electrolyte that impregnates the electrode assembly.

During repeated charging and discharging of the lithium secondary battery, the cathode may collapse due to the intercalation and deintercalation of lithium ions into and from a cathode active material. As a result, problems such as gas generation due to side reactions between the cathode active material and an electrolyte, and degradation in the cycle life characteristics of the lithium secondary battery may occur. In addition, the above-described problems may be more pronounced during repeated fast charging and discharging.

Recently, batteries with greater stability and higher capacity have been implemented by adjusting the types and contents of cathode active materials, binders, and conductive materials. In addition, the composition of the electrode active material layer is adjusted to improve the low-temperature characteristics of the battery or to increase the energy density.

### SUMMARY

An object of the present disclosure is to provide a cathode for a secondary battery capable of providing improved productivity.

Another object of the present disclosure is to provide a lithium secondary battery including the cathode.

A cathode for a secondary battery according to exemplary embodiments of the present disclosure includes: a cathode current collector; and a cathode active material layer disposed on one surface of the cathode current collector. The cathode active material layer includes: a cathode active material and a binder. The cathode active material includes first particles including lithium iron phosphate. The binder includes a first fluorine-based polymer and a second fluorine-based polymer having a hydrophilic functional group bound to the first fluorine-based polymer.

In exemplary embodiments, the hydrophilic functional group may include at least one selected from the group consisting of a carbonyl group, a hydroxyl group, an epoxy group and an amine group.

In exemplary embodiments, the molecular weight of the second fluorine-based polymer may be greater than or equal to that of the first fluorine-based polymer.

In exemplary embodiments, the first fluorine-based polymer may be polyvinylidene fluoride (PVDF).

In exemplary embodiments, a ratio of the content of the second fluorine-based polymer to the content of the first fluorine-based polymer, based on the total weight of the cathode active material layer, may be 0.1 to 3.

In exemplary embodiments, the content of the first fluorine-based polymer may be 0.1% by weight to 3% by weight, based on the total weight of the cathode active material layer, and the content of the second fluorine-based polymer may be 0.01% by weight to 1% by weight, based on the total weight of the cathode active material layer.

In exemplary embodiments, the content of the first fluorine-based polymer may be 0.5 to 1% by weight, and the content of the second fluorine-based polymer may be 0.5 to 1% by weight, based on the total weight of the cathode active material layer.

In exemplary embodiments, the lithium iron phosphate may include a compound represented by Formula 1 below:

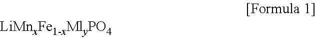

In Formula 1, 0<x≤1, and 0≤y≤0.05, and M1 may include at least one of Co, Al, Na, Mg, Ca, Y, Ti, Hf, V, Nb, Ta, Cr, Mo, W, Cu, Ag, Zn, Ga, C, Si, Sn, Sr, Ba, Ra and Zr.

In exemplary embodiments, the cathode active material may further include second particles including a lithium nickel metal oxide.

In exemplary embodiments, the second particles may have a single particle structure.

In exemplary embodiments, a ratio of the content of the first particles to the content of the second particles, based on the total weight of the cathode active material, may be 1.5 to 3.

In exemplary embodiments, the second particles may have a median particle diameter (D50) of 2 μm to 5 μm.

In exemplary embodiments, the content of nickel, based on the total moles of elements other than lithium and oxygen in the lithium nickel metal oxide, may be 50 mol % to 99 mol %.

In exemplary embodiments, the lithium nickel metal oxide may include a compound represented by the following Formula 2:

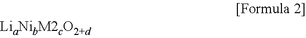

In Formula 2, 0.9≤a≤1.2, 0.5≤b≤0.99, 0.01≤c≤0.5, and −0.5≤d≤0.1, and M2 may include at least one of Co, Mn, Al, Na, Mg, Ca, Y, Ti, Hf, V, Nb, Ta, Cr, Mo, W, Fe, Cu, Ag, Zn, Ga, C, Si, Sn, Sr, Ba, Ra, P and Zr.

In exemplary embodiments, the cathode active material layer may further include a conductive material.

A lithium secondary battery according to exemplary embodiments of the present disclosure includes: the cathode for a secondary battery; and an anode disposed opposite to the cathode.

In the cathode for a secondary battery according to exemplary embodiments of the present disclosure, the adhesion between the cathode active material layer and the cathode current collector may be improved. Accordingly, the durability of the cathode may be enhanced, and delamination of the cathode active material layer may be suppressed even during repeated charging and discharging of a battery including the cathode, and the cycle life characteristics of the cathode and the battery may be improved.

The lithium secondary battery according to exemplary embodiments of the present disclosure may exhibit improved cycle life characteristics and reduced capacity loss due to repeated charging and discharging.

The cathode for a secondary battery of the present disclosure and the lithium secondary battery including the same may be widely applied in green technology fields, such as electric vehicles, battery charging stations, as well as solar power generation, wind power generation, and the like, which use the batteries. In addition, the cathode for a secondary battery of the present disclosure and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a plan view of a lithium secondary battery according to an embodiment; and

FIG. 2 is a schematic cross-sectional view of the lithium secondary battery according to an embodiment.

### DETAILED DESCRIPTION

A cathode for a secondary battery (hereinafter, also abbreviated as a “cathode”) according to an exemplary embodiment of the present disclosure includes a cathode active material layer including different types of cathode active materials and different types of binders. A lithium secondary battery according to an exemplary embodiment of the present disclosure includes the cathode.

Hereinafter, the embodiments of the present disclosure will be described in detail.

However, these embodiments are merely examples, and the present disclosure is not limited to the specific embodiments described as example.

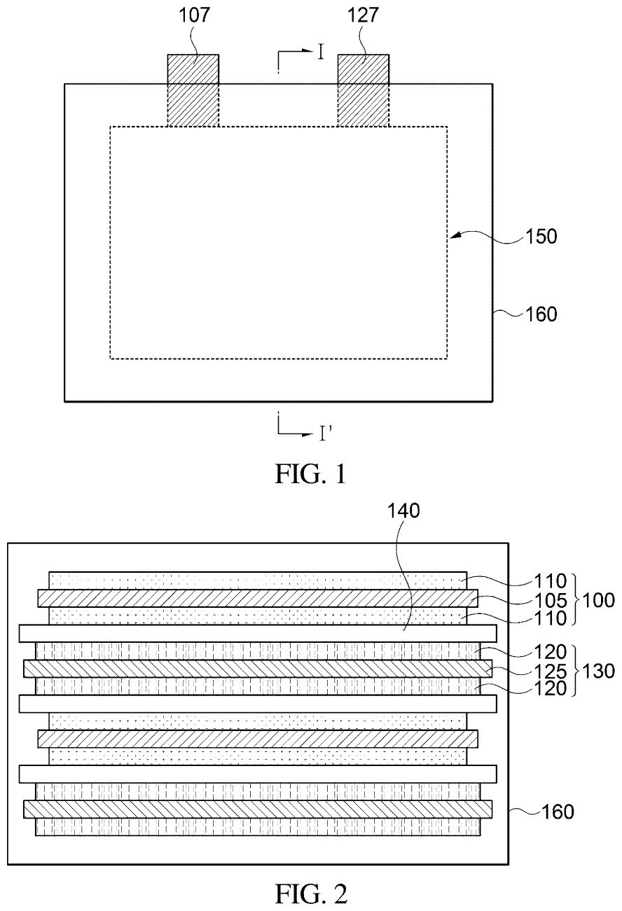

FIGS. 1 and 2 are schematic plan and cross-sectional views illustrating a lithium secondary battery according to exemplary embodiments, respectively. For example, FIG. 2 is a cross-sectional view taken along line I-I′ of FIG. 1 in the thickness direction.

Referring to FIGS. 1 and 2, the lithium secondary battery may include a cathode 100 including the above-described cathode active material and an anode 130 disposed opposite to the cathode 100.

The cathode 100 may include a cathode current collector 105 and a cathode active material layer 110 disposed on at least one surface of the cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may be disposed on both surfaces of the cathode current collector 105.

The cathode active material layer 110 includes a cathode active material. The cathode active material includes first particles including lithium iron phosphate.

The lithium iron phosphate may be more stable than lithium nickel metal oxide.

Accordingly, the stability of the cathode and the battery may be improved, and the cycle life characteristics of the battery may be enhanced, compared to when the cathode active material is composed only of lithium nickel metal oxide.

In exemplary embodiments, the lithium iron phosphate may further include other metal elements different from lithium and iron. For example, the lithium iron phosphate may further include manganese.

In exemplary embodiments, the lithium iron phosphate may include a compound represented by Formula 1 below.

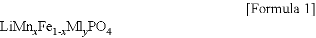

In Formula 1, x and y may satisfy 0<x≤1, and 0≤y≤0.05, and M1 may include at least one of Co, Mn, Al, Na, Mg, Ca, Y, Ti, Hf, V, Nb, Ta, Cr, Mo, W, Cu, Ag, Zn, Ga, C, Si, Sn, Sr, Ba, Ra and Zr.

In Formula 1, x may be in the range of 0.3≤x≤0.9, 0.4≤x≤0.8, or 0.5≤x≤0.7. Within the above range, the energy density of the cathode active material including the first particles and the cathode including the same may be further increased.

In one embodiment, the lithium iron phosphate may be an olivine-type lithium phosphate compound represented by Formula 1. The olivine-type lithium phosphate compound may have high structural stability. The chemical structure represented by Formula 1 above indicates a bonding relationship between elements included in the lithium iron phosphate and does not exclude other additional elements.

In exemplary embodiments, the first particles may have a median particle diameter (D50) of 0.3 μm to 1.3 μm. In some embodiments, the first particles may have a median particle diameter (D50) of 0.5 μm to 1.1 μm, or 0.6 μm to 0.9 μm. Within the above range, a cathode active material layer may be formed without excessively large voids when mixed with the second particles.

The “median particle diameter (D50)” may refer to a particle diameter value at which 50% of the volume-based cumulative distribution is reached.

According to exemplary embodiments, the cathode active material may further include second particles including lithium nickel metal oxide.

The lithium nickel metal oxide may have a higher energy density than the lithium iron phosphate, and lithium ions may be smoothly intercalated and deintercalated even at low temperatures. Accordingly, the capacity of the cathode and the battery may be increased compared to when the cathode active material is composed only of lithium iron phosphate, and the cathode may be applied to a battery used in a low-temperature environment.

In exemplary embodiments, the content of nickel, based on the total moles of elements other than lithium and oxygen in the lithium nickel metal oxide, may be 50 mol % to 99 mol %. In some embodiments, the content of nickel, based on the total moles of elements other than lithium and oxygen in the lithium nickel metal oxide, may be 60 mol % to 95 mol %. Accordingly, a high-capacity battery may be implemented because the lithium nickel metal oxide has a high nickel content.

In exemplary embodiments, the lithium nickel metal oxide may include a compound represented by Formula 2 below.

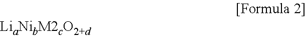

In Formula 2, a, b, c and d may satisfy 0.9≤a≤1.2, 0.5≤b≤0.99, 0.01≤c≤0.5, and −0.5≤d≤0.1. M2 may include at least one of Co, Mn, Al, Na, Mg, Ca, Y, Ti, Hf, V, Nb, Ta, Cr, Mo, W, Fe, Cu, Ag, Zn, Ga, C, Si, Sn, Sr, Ba, Ra, P and Zr.

In Formula 2, b may be in the range of 0.6≤b≤0.95 or 0.65≤b≤0.9.

In Formula 2, M2 may include Co and Mn, and c may be in the range of0.05≤c≤0.4 or 0.1≤c≤0.35.

In one embodiment, the lithium nickel metal oxide may include a layered structure or a crystal structure represented by Formula 2 above. The chemical structure represented by Formula 2 above indicates a bonding relationship between elements included in the lithium nickel metal oxide and does not exclude other additional elements.

In some embodiments, the lithium nickel metal oxide may include a layered structure or crystal structure represented by Formula 3 below.

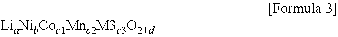

In Formula 3, a, b, c1 and c2 may satisfy 0.9≤a≤1.2, 0.5≤b≤0.99, 0<c1≤0.15, 0<c2≤0.35, 0≤c3<0.5, and 0.5≤d≤0.1. M3 may include at least one of Al, Na, Mg, Ca, Y, Ti, Hf, V, Nb, Ta, Cr, Mo, W, Fe, Cu, Ag, Zn, Ga, C, Si, Sn, Sr, Ba, Ra, P and Zr.

In Formula 3 above, M3 may function as an auxiliary element. The auxiliary element may be incorporated into the layered structure/crystal structure together with the main active elements to form bonds. In addition, the auxiliary element may be added to the main active elements such as nickel, cobalt and manganese to enhance the chemical stability of the cathode active material or the layered structure/crystal structure.

In exemplary embodiments, the second particles may have a single particle structure.

The term “single particle structure” as used herein refers to a structure that excludes, for example, a secondary particle formed by aggregation or assembly of a plurality of primary particles (e.g., greater than 10) into a substantially single particle.

For example, the second particles may be composed of particles having a substantially single particle form, and a secondary-particle structure in which primary particles are assembled or aggregated may be excluded. In addition, the term “single particle structure” as used herein does not exclude a structure in which 2 to 10 single particles are attached to or in close contact with each other to form a monolithic shape.

In some embodiments, the second particles may include a structure in which a plurality of primary particles are integrally fused together and substantially transformed into a single particle form.

For example, the second particles may have a single particle structure including 10 or fewer crystal grains.

For example, the lithium nickel metal oxide particles may have a single-crystal structure. The term “single-crystal structure” may refer to a structure in which a single particle is composed of a single crystal grain. For example, the single-crystal structure may be identified based on an ion image obtained by analyzing the particle cross-section using a focused ion beam (FIB). If the particle has a single-crystal structure, a single crystal may be observed in the FIB analysis image depending on the difference in crystal orientation.

In exemplary embodiments, the second particles may have a median particle diameter (D50) of 2 μm to 5 μm. In some embodiments, the second particles may have a median particle diameter (D50) of 2.5 μm to 4.5 μm or 3 μm to 4 μm. Within the above range, a cathode active material layer with a high energy density may be implemented.

The cathode active material may further include another cathode active material in addition to the first particles and the second particles. For example, the cathode active material may further include a lithium cobalt oxide-based active material, a lithium manganese oxide-based active material, or a lithium iron phosphate (LFP)-based active material (e.g., LiFePO₄), and may also include a lithium metal oxide that does not have a single particle structure (e.g., a secondary-particle structure).

In some embodiments, the cathode active material may include a mixture of the first particles and the second particles, and for example, the cathode active material may be substantially composed of the mixture of the first particles and the second particles.

In exemplary embodiments, the content of the cathode active material, based on the total weight of the cathode active material layer, may be 90 wt % to 99 wt %. In some embodiments, the content of the cathode active material, based on the total weight of the cathode active material layer, may be 95 wt % to 98 wt %.

In exemplary embodiments, the content of the first particles, based on the total weight of the cathode active material, may be 50 wt % to 90 wt %. In some embodiments, the content of the first particles, based on the total weight of the cathode active material, may be 60 wt % to 80 wt %, or 65 wt % to 75 wt %.

In exemplary embodiments, the content of the second particles, based on the total weight of the cathode active material, may be 10 wt % to 40 wt %. In some embodiments, the content of the second particles, based on the total weight of the cathode active material, may be 20 wt % to 40 wt %, or 25 wt % to 35 wt %.

Within the above range, a battery having both high energy density and improved stability may be implemented.

In exemplary embodiments, a ratio of the content of the first particles to the content of the second particles, based on the total weight of the cathode active material, may be 1.5 to 3. In some embodiments, the ratio of the content of the first particles to the content of the second particles, based on the total weight of the cathode active material, may be 1.7 to 2.8, or 2 to 2.5.

Within the above range, the content of the first particles may be greater than the content of the second particles, and the stability of the battery may be improved without a significant decrease in capacity.

The cathode active material layer includes a binder. The binder is an organic polymer that may bind the first particles and the second particles together to form the cathode active material layer.

The binder includes a first fluorine-based polymer and a second fluorine-based polymer having a hydrophilic functional group bound to the first fluorine-based polymer. The second fluorine-based polymer may be a fluorine-based polymer in which a hydrophilic functional group is bonded to the first fluorine-based polymer. Since the binder includes two types of fluorine-based polymers, a uniform cathode slurry may be formed, and the adhesion between the cathode current collector and the cathode active material layer may be improved.

If the binder does not include the second fluorine-based polymer, the electrode adhesion may become excessively low, and the cathode active material layer may be delaminated from the cathode current collector during the roll-pressing process.

The first fluorine-based polymer may include polyvinylidene fluoride (PVDF), poly(vinylidene fluoride-co-hexafluoropropylene) and the like. These may be used alone or in combination of two or more thereof.

For example, the first fluorine-based polymer may include polyvinylidene fluoride (PVDF).

The first fluorine-based polymer may not include the hydrophilic functional group described below. Accordingly, this may prevent the viscosity of the cathode slurry from increasing excessively.

The second fluorine-based polymer may be prepared by introducing a hydrophilic functional group into the first fluorine-based polymer, or alternatively, a commercially available product may be purchased and used as the second fluorine-based polymer.

In exemplary embodiments, the hydrophilic functional group may include a carbonyl group, a hydroxyl group, an epoxy group, an amine group, or the like. These may be used alone or in combination of two or more thereof.

In exemplary embodiments, the first fluorine-based polymer may have a weight average molecular weight (Mw) of 500,000 to 1,000,000 g/mol. In some embodiments, the first fluorine-based polymer may have a weight average molecular weight (Mw) of 550,000 to 800,000 g/mol.

In exemplary embodiments, the second fluorine-based polymer may have a weight average molecular weight (Mw) of 800,000 to 1,300,000 g/mol. In some embodiments, the second fluorine-based polymer may have a weight average molecular weight (Mw) of 840,000 to 1,260,000 g/mol.

In exemplary embodiments, the molecular weight of the second fluorine-based polymer may be greater than or equal to that of the first fluorine-based polymer. Accordingly, agglomeration and clumping of polymers in the cathode slurry may be suppressed, and a uniform cathode active material layer may be formed.

In exemplary embodiments, the content of the first fluorine-based polymer may be 0.1 wt % to 3 wt %, based on the total weight of the cathode active material layer. In some embodiments, the content of the first fluorine-based polymer may be 0.2 wt % to 2 wt %, or 0.5 wt % to 1.5 wt %, based on the total weight of the cathode active material layer. In exemplary embodiments, the content of the first fluorine-based polymer may be 0.5 wt % or more, 0.75 wt % or more, 1 wt % or more, or 1 wt % or less, 0.75 wt % or less, or 0.5 wt % or less. In exemplary embodiments, the content of the first fluorine-based polymer may be 0.5 to 1 wt %.

In exemplary embodiments, the content of the second fluorine-based polymer may be 0.01 wt % to 1 wt %, based on the total weight of the cathode active material layer. In some embodiments, the content of the second fluorine-based polymer may be 0.1 wt % to 0.7 wt %, or 0.3 wt % to 0.6 wt %, based on the total weight of the cathode active material layer. In exemplary embodiments, the content of the second fluorine-based polymer may be 0.5 wt % or more, 0.75 wt % or more, 1 wt % or more, or 1 wt % or less, 0.75 wt % or less, or 0.5 wt % or less. In exemplary embodiments, the content of the second fluorine-based polymer may be 0.5 to 1 wt %.

In exemplary embodiments, a ratio of the content of the second fluorine-based polymer to the content of the first fluorine-based polymer, based on the total weight of the cathode active material layer, may be 0.1 to 3. In some embodiments, the ratio of the content of the second fluorine-based polymer to the content of the first fluorine-based polymer, based on the total weight of the cathode active material layer, may be 0.2 to 2.5, or 0.5 to 2.

Within the above range, the adhesion between the cathode active material layer and the cathode current collector may be improved, thereby enhancing the processability in the cathode manufacturing process.

In exemplary embodiments, the cathode active material layer may further include a conductive material. The conductive material may compensate for the reduction in electrical conductivity of the cathode active material layer caused by the binder.

The conductive material may include carbon-based conductive materials such as graphite, carbon black, acetylene black, Ketjen black, graphene, carbon nanotubes, vapor-grown carbon fibers (VGCFs), carbon fibers, and/or metal-based conductive materials, including perovskite materials, such as tin, tin oxide, titanium oxide, LaSiCoO₃, and LaSrMnO₃. For example, the conductive material may include carbon nanotubes.

The content of the conductive material, based on the total weight of the cathode active material layer, may be 0.01 wt % to 3 wt %. In some embodiments, the content of the conductive material, based on the total weight of the cathode active material layer, may be 0.1 wt % to 1 wt %.

The cathode active material layer may further include a thickener and/or a dispersant. For example, the cathode active material layer may include a thickener such as carboxymethyl cellulose (CMC).

The cathode active material layer 110 may be formed from a cathode slurry composition including a cathode active material and a binder. For example, the cathode active material layer 110 may be prepared by applying the cathode slurry composition including a cathode active material and a binder to one surface of the cathode current collector 105, and then drying and roll-pressing the applied layer.

According to exemplary embodiments, the cathode slurry composition may include a solvent. As the solvent, N-methyl-2-pyrrolidone (NMP), dimethylformamide, dimethylacetamide, N,N-dimethylaminopropylamine, ethylene oxide, tetrahydrofuran, and the like may be used.

According to exemplary embodiments, the content of solids based on the total weight of the cathode slurry composition may be 50 wt % to 70 wt %. According to some embodiments, the content of solids based on the total weight of the cathode slurry composition may be 53 wt % to 60 wt %, or 55 wt % to 58 wt %.

The term “solids” refers to components that are dissolved or dispersed in the solvent of the slurry, and may include solid components distinct from the solvent. For example, the solids in the cathode slurry composition may include a cathode active material and a binder, and may further include additives such as a conductive material, a thickener, and a dispersant.

According to exemplary embodiments, the cathode slurry composition may have a viscosity of 4000 cps to 5000 cps. According to some embodiments, the cathode slurry composition may have a viscosity of 4200 cps to 4500 cps.

Within the above range, the cathode slurry composition may have improved coatability and may be formed into a cathode active material layer with appropriate processability.

The application of the cathode slurry composition may be performed by processes such as gravure coating, slot die coating, simultaneous multilayer die coating, imprinting, doctor blade coating, dip coating, bar coating, casting, or the like, and is not limited thereto.

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with a conductive metal and the like. These may be used alone or in combination of two or more thereof. For example, the anode current collector 125 may have a thickness of 10 μm to 50 μm.

The anode active material layer 120 may include an anode active material. As the anode active material, a material capable of intercalating and deintercalating lithium ions may be used. For example, as the anode active material, carbon-based materials such as crystalline carbon, amorphous carbon, a carbon composite, or carbon fibers, etc.; lithium metal; a lithium alloy; a silicon (Si)-containing material or a tin (Sn)-containing material, etc. may be used.

These may be used alone or in combination of two or more thereof.

The amorphous carbon may include hard carbon, soft carbon, cokes, mesocarbon microbead (MCMB), mesophase pitch-based carbon fiber (MPCF) or the like.

The crystalline carbon may include graphite-based carbon such as natural graphite, artificial graphite, graphite cokes, graphite MCMB, graphite MPCF or the like.

The lithium metal may include pure lithium metal and/or lithium metal having a protective layer formed thereon for suppressing dendrite growth and the like. In one embodiment, a lithium metal-containing layer deposited or coated on the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating, casting or the like. The anode active material layer 120 may further include a binder, and optionally may further include a conductive material, a thickener or the like.

The solvent included in the anode slurry may include water, pure water, deionized water, distilled water, ethanol, isopropanol, methanol, acetone, n-propanol, t-butanol and the like.

These may be used alone or in combination of two or more thereof.

The above-described materials that can be used when preparing the cathode 100 as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow the flow of ions. For example, the separation membrane may have a thickness of 10 μm to 20 μm.

For example, the separation membrane 140 may include a porous polymer film or a porous nonwoven fabric.

The porous polymer film may include a polyolefm-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, and propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted cyclic carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluoro phosphate, etc.

The borate compound may include lithium bis(oxalate) borate, etc.

As shown in FIGS. 1 and 2, electrode tabs (cathode tabs and anode tabs) may protrude from the cathode current collector 105 and the anode current collector 125 belonging to each electrode cell and extend to one side portion of the case 160, respectively. The electrode tabs may be fused together with the one side portion of the outer case 160 to form electrode leads (a cathode lead 107 and an anode lead 127) that extend or are exposed to the outside of the outer case 160.

The lithium secondary battery may be manufactured in a cylindrical shape using a can, a prismatic shape, a pouch shape, a coin shape, etc., for example.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples are possible within the scope and technical idea of the present disclosure, and it is also natural that such changes and modifications fall within the scope of the appended claims.

### Example 1

LiMn_{0.6}Fe_{0.4}PO₄ particles (D50: 0.87 μm) as a cathode active material, PVDF (weight average molecular weight: 570,000 to 716,000 g/mol) as a first fluorine-based polymer, PVDF (weight average molecular weight: 840,000 to 1,260,000 g/mol) with bonded carbonyl and hydroxyl groups as a second fluorine-based polymer, and carbon nanotubes (CNTs) as a conductive material were mixed in a weight ratio of 97.9:0.5:1:0.6 using N-methyl-2-pyrrolidone (NMP) as a solvent to prepare a cathode slurry.

### Example 2

A cathode slurry was prepared in the same manner as in Example 1, except that the weight ratio of the cathode active material, the first fluorine-based polymer, the second fluorine-based polymer and the conductive material was changed to 97.9:1:0.5:0.6.

### Example 3

A cathode slurry was prepared in the same manner as in Example 1, except that a cathode active material including LiMn_{0.6}Fe_{0.4}PO₄ particles (D50: 0.87 μm) and LiNi_{0.6}Co_{0.1}Mn_{0.3}O₂ particles (D50: 3.8 μm) having a single particle structure in a weight ratio of 7:3 was used.

### Example 4

A cathode slurry was prepared in the same manner as in Example 3, except that the weight ratio of the cathode active material, the first fluorine-based polymer, the second fluorine-based polymer and the conductive material was changed to 97.9:0.75:0.75:0.6.

### Example 5

A cathode slurry was prepared in the same manner as in Example 3, except that the weight ratio of the cathode active material, the first fluorine-based polymer, the second fluorine-based polymer and the conductive material was changed to 97.9:1:0.5:0.6.

### Comparative Example 1

A cathode slurry was prepared in the same manner as in Example 1, except that the cathode active material, PVDF as the first fluorine-based polymer, and CNTs as the conductive material were mixed in a weight ratio of 97.9:1.5:0.6 during the preparation of the cathode slurry.

### Comparative Example 2

A cathode slurry was prepared in the same manner as in Example 1, except that the cathode active material, the second fluorine-based polymer, and CNTs as the conductive material were mixed in a weight ratio of 97.9:1.5:0.6 during the preparation of the cathode slurry.

### Comparative Example 3

A cathode slurry was prepared in the same manner as in Example 3, except that the cathode active material, PVDF as the first fluorine-based polymer, and CNTs as the conductive material were mixed in a weight ratio of 97.9:1.5:0.6 during the preparation of the cathode slurry.

### Comparative Example 4

A cathode slurry was prepared in the same manner as in Example 3, except that the cathode active material, the second fluorine-based polymer and CNTs as the conductive material were mixed in a weight ratio of 97.9:1.5:0.6 during the preparation of the cathode slurry.

The cathode compositions of the examples and comparative examples are shown in Table 1 below. Table 1 also shows the contents of the first particles and the second particles based on the total weight of the cathode active material, and the contents of the first fluorine-based polymer and the second fluorine-based polymer based on the total weight of the solid content in the slurry composition.

TABLE 1

| | Cathode active | | | |
|---|---|---|---|---|
| | material | | Binder | |
| | First | Second | First fluorine- | Second fluorine- |
| | particle | particle | based polymer | based polymer |
| | (wt %) | (wt %) | (wt %) | (wt %) |
| Example1 | 100 | — | 0.5 | 1 |
| Example2 | 100 | — | 1 | 0.5 |
| Example3 | 70 | 30 | 0.5 | 1 |
| Example4 | 70 | 30 | 0.75 | 0.75 |
| Example5 | 70 | 30 | 1 | 0.5 |
| Comparative | 100 | — | 1.5 | 0 |
| Example1 | | | | |
| Comparative | 100 | — | 0 | 1.5 |
| Example2 | | | | |
| Comparative | 70 | 30 | 1.5 | 0 |
| Example3 | | | | |
| Comparative | 70 | 30 | 0 | 1.5 |
| Example4 | | | | |

### Experimental Example 1: Evaluation of Slurry Characteristics

The solvent (N-methyl-2-pyrrolidone, NMP) was mixed so that the solid content in the cathode slurry of the examples and comparative examples was set to 57 wt %, and the viscosity at 25° C. was measured under the following measurement conditions: Brookfield Viscometer (model DV3T), spindle No. 64, and a rotation speed of 10 rpm. The measurement results are shown in Table 2 below.

### Manufacture of Battery

The cathode slurry of the examples and comparative examples was diluted to have a viscosity of 4500 cps by adding a solvent (N-methyl-2-pyrrolidone, NMP), and was applied to one surface of an aluminum foil (thickness: 12 μm), and then dried and roll-pressed to fabricate a cathode. The thickness of the cathode active material layer was 70 μm.

An anode slurry was prepared by mixing artificial graphite, natural graphite, styrene butadiene rubber as a binder, and cellulose as a thickener in a weight ratio of 68.32:29.28:1.2:1.2, and using water as a solvent.

The anode slurry was applied to one surface of a copper foil (thickness: 6 am), and then dried and roll-pressed to fabricate an anode. The thickness of the anode active material layer was 60 μm.

The cathode and anode were notched to a predetermined size and stacked, with a separator (polyethylene, thickness: 13 μm) interposed between the cathode and anode. The stacked assembly was placed into a pouch-type outer material, and three sides were sealed. An electrolyte was injected through the remaining one side, and the remaining side was also sealed to manufacture a secondary battery.

As the electrolyte, a solution in which LiPF₆ was dissolved at a concentration of 1 M in a solvent mixture of ethylene carbonate and ethyl methyl carbonate at a volume ratio of 1:1 was used.

### Experimental Example 2: Evaluation of Adhesion of Cathode

A 90° peel test was performed on the cathodes of the examples and comparative examples using a COAD.204 adhesion tester to measure the adhesion between the cathode active material layer and the cathode current collector. The measurement results are shown in Table 2 below.

### Experimental Example 3: Evaluation of Cycle Life Characteristics of Battery

A cycle life characteristic evaluation was performed on the batteries of the examples and comparative examples at 25° C. within the range of DOD 94% (SOC 2-96%). The batteries were charged at 0.3 C to a voltage corresponding to SOC 96% under constant current/constant voltage (CC/CV) conditions, followed by a cut-off at 0.05 C. The batteries were then discharged at 0.5 C to a voltage corresponding to SOC 2% under constant current (CC) conditions, and the discharge capacity was measured. This procedure was repeated for 400 cycles, and the capacity retention rate was calculated as the percentage (%) of the discharge capacity retained compared to the initial discharge capacity. The results of the capacity retention rate evaluated for the room-temperature cycle life are shown in Table 2 below.

TABLE 2

| | Viscosity (25° C., | Adhesion | Capacity retention |
|---|---|---|---|
| | 57 wt %) (cps) | (N) | rate (%) |
| Example 1 | 7400 | 0.75 | 93.8 |
| Example 2 | 6640 | 0.6 | 93.8 |
| Example 3 | 4870 | 0.89 | 98 |
| Example 4 | 4450 | 0.7 | 98.9 |
| Example 5 | 4100 | 0.4 | 99.5 |
| Comparative | 4000 | 0.1 | Cell fabrication failed |
| Example 1 | | | |
| Comparative | 8500 | 0.89 | 93.8 |
| Example 2 | | | |
| Comparative | 2700 | 0.1 | Cell fabrication failed |
| Example 3 | | | |
| Comparative | 8000 | 1.1 | 96.5 |
| Example 4 | | | |

Referring to Table 2, in the cathodes of the examples, the adhesion between the cathode active material layer and the cathode current collector was very strong, and the cycle life characteristics of the battery including the cathode were significantly improved.

On the other hand, when the cathode slurry of Comparative Examples 1 and 3, which did not include the second fluorine-based polymer, was used, the adhesion was so poor that the cathode active material layer peeled off during the cathode fabrication, resulting in failure to form a cell.

The cathode slurry of Comparative Examples 2 and 4, which did not include the first fluorine-based polymer, had an excessively high viscosity, making it difficult to form the cathode active material layer. When the cathode slurry of Comparative Examples 2 and 4 was diluted to fabricate cathodes, the productivity of the battery decreased due to reduced drying processability and slower coating speed resulting from the increased amount of solvent.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A cathode for a secondary battery comprising:
a cathode current collector; and
a cathode active material layer disposed on one surface of the cathode current collector,
wherein the cathode active material layer comprises:
a cathode active material comprising first particles including lithium iron phosphate; and
a binder comprising a first fluorine-based polymer and a second fluorine-based polymer having a hydrophilic functional group bound to the first fluorine-based polymer.

2. The cathode for a secondary battery according to claim 1, wherein the hydrophilic functional group comprises at least one selected from the group consisting of a carbonyl group, a hydroxyl group, an epoxy group and an amine group.

3. The cathode for a secondary battery according to claim 1, wherein the molecular weight of the second fluorine-based polymer is greater than or equal to that of the first fluorine-based polymer.

4. The cathode for a secondary battery according to claim 1, wherein the first fluorine-based polymer is polyvinylidene fluoride (PVDF).

5. The cathode for a secondary battery according to claim 1, wherein a ratio of the content of the second fluorine-based polymer to the content of the first fluorine-based polymer, based on the total weight of the cathode active material layer, is 0.1 to 3.

6. The cathode for a secondary battery according to claim 1, wherein the content of the first fluorine-based polymer is 0.1% by weight to 3% by weight, based on the total weight of the cathode active material layer, and the content of the second fluorine-based polymer is 0.01% by weight to 1% by weight, based on the total weight of the cathode active material layer.

7. The cathode for a secondary battery according to claim 1, wherein the content of the first fluorine-based polymer is 0.5 to 1% by weight, and the content of the second fluorine-based polymer is 0.5 to 1% by weight, based on the total weight of the cathode active material layer.

8. The cathode for a secondary battery according to claim 1, wherein the first fluorine-based polymer does not comprise the hydrophilic functional group.

9. The cathode for a secondary battery according to claim 1, wherein the lithium iron phosphate comprises a compound represented by Formula 1 below: 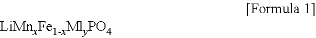
(in Formula 1, 0<x≤1, and 0≤y≤0.05, and M1 comprises at least one of Co, Al, Na, Mg, Ca, Y, Ti, Hf, V, Nb, Ta, Cr, Mo, W, Cu, Ag, Zn, Ga, C, Si, Sn, Sr, Ba, Ra and Zr).

10. The cathode for a secondary battery according to claim 1, wherein the cathode active material further comprises second particles including a lithium nickel metal oxide.

11. The cathode for a secondary battery according to claim 10, wherein the second particles have a single particle structure.

12. The cathode for a secondary battery according to claim 10, wherein a ratio of the content of the first particles to the content of the second particles, based on the total weight of the cathode active material, is 1.5 to 3.

13. The cathode for a secondary battery according to claim 10, wherein the second particles have a median particle diameter (D50) of 2 μm to 5 μm.

14. The cathode for a secondary battery according to claim 10, wherein the content of nickel, based on the total moles of elements other than lithium and oxygen in the lithium nickel metal oxide, is 50 mol % to 99 mol %.

15. The cathode for a secondary battery according to claim 10, wherein the lithium nickel metal oxide comprises a compound represented by the following Formula 2: 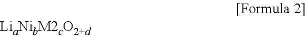
(in Formula 2, 0.9≤a≤1.2, 0.5≤b≤0.99, 0.01≤c≤0.5, and −0.5≤d≤0.1, and M2 comprises at least one of Co, Mn, Al, Na, Mg, Ca, Y, Ti, Hf, V, Nb, Ta, Cr, Mo, W, Fe, Cu, Ag, Zn, Ga, C, Si, Sn, Sr, Ba, Ra, P and Zr).

16. The cathode for a secondary battery according to claim 1, wherein the cathode active material layer further comprises a conductive material.

17. A lithium secondary battery comprising:
the cathode for a secondary battery according to claim 1; and
an anode disposed opposite to the cathode.
